(19) United States
(12) Patent Application Publication
(10) Pub. No.: US 2010/0100926 A1
(43) Pub. Date: Apr. 22, 2010

(54) INTERACTIVE SELECTION OF IDENTITY INFORMATOIN SATISFYING POLICY CONSTRAINTS

(76) Inventors: Carl Binding, Rueschlikon (CH); Anthony Bussani, Adliswil (CH); Jan Camenisch, Thalwil (CH); Dieter M. Sommer, Zurich (CH)

Correspondence Address: TUTUNJIAN & BITETTO, P.C., 20 CROSSWAYS PARK NORTH, SUITE 210, WOODBURY, NY, 11797, US

(21) Appl. No.: 12/252,598

(22) Filed: Oct. 16, 2008

(51) Int. Cl. G06F 21/24

(52) U.S. Cl. 726/1

(57) ABSTRACT

A system and method for verifying an attribute includes providing a compound policy by a relying party. The compound policy has one or more claims and/or sub-claims expressing conditions on attributes and constants. Identity providers are associated with aspects of the compound policy by mapping attributes of the compound policy with attributes of the identity providers. A selection of at least one identity provider that satisfies the compound policy is enabled. At least one attribute of the user is verified by at least one identity provider in accordance with the selection.

### BACKGROUND

1. Technical Field

The present invention relates to identity verification and more particularly to systems and methods for selecting an identity management provider in accordance with policy constraints using an interactive interface.

2. Description of the Related Art

Identity management systems are used to store digital information on subjects. Such systems describe each subject via a set of (identity) attributes such as, e.g., given name, first name, nationality, address, date of birth etc., but also other credentials of the user such as access rights or job qualification. When requiring access to a given service (provided by a relying party as a web service or a web site's page), identity information is extracted from the identity management's identity provider(s), signed (and thus certified) by the identity provider(s), and presented to the relying party which either accepts or rejects the credentials presented in the form of some security token.

Access to the trusted identity provider (also referred to as a secure token service since it generates the secure access token) is granted upon presentation of some authentication token such as, e.g., a user credential and password, or an X509 certificate based authenticator, or a Kerberos ticket.

In a simplistic scheme, the relying party can require which set of identity attributes should be provided and certified by the identity provider. For example, the Microsoft® Information Card system (a.k.a., CardSpace) knows a limited set of identity attributes for which the trusted identity provider supplies the value(s), creates an authenticated credential (in the form of, e.g., a SAML token) containing these values and forwards these to the relying party.

An end user selects the identity provider to generate the security token by choosing from a set of digital cards presented by an identity management user interface. The selected card identifies the identity provider and only cards for identity providers able to supply the required identity attributes can be selected by the user.

A Microsoft® Information Card system uses a simple scheme to express which attributes must be supplied and certified by the identity provider: it uses a set of well-known identity attributes for which the values are extracted from the identity provider and certified by using a cryptographic signing scheme. The advantage of such a system is that the end-user has a simple paradigm (i.e., card selection) to indirectly select an identity provider. Furthermore, the maintenance of the attribute values required by the relying party and stored by the identity provider is delegated to the identity provider. Thus, data maintenance requirements become simplified. Each information card may also restrict the set of identity attributes to a subset of all available identity attributes and thus control the release of personal information to the relying party. Finally, the same identity provider can be used for multiple relying parties, thus providing a single sign on to multiple relying parties.

### SUMMARY

The above model can be extended by federating the identity providers. For example, a set of identity attributes can be provided by one or multiple federated identity (id) providers. Identity mixer technology extends this paradigm by using a more complex policy language. That is, the relying party can formulate access requirements not only as a set of certified attribute values, but as conditional predicates on a set of attributes.

One embodiment of the present invention may include a mechanism to automatically generate mappings from policy claim attributes onto identity provider attributes using a set of computable, semantics preserving transformations. At the user level, however, the user should be presented with the set of cards which eventually satisfy the policy claims of the relying party. For each card, the system indicates which attributes are supplied by the identity party associated with the card. The present embodiments provide an easy-to-use, expressive, and sufficiently powerful user-interface for the selection of cards.

A system and method for verifying an attribute includes providing a compound policy by a relying party. The compound policy has one or more claims and/or sub-claims expressing conditions on attributes and constants. Identity providers are associated with aspects of the compound policy by mapping attributes of the compound policy with attributes of the identity providers. A selection of at least one identity provider that satisfies the compound policy is enabled. At least one attribute of the user is verified by at least one identity provider in accordance with the selection.

A system for verifying an attribute includes an identity selector configured on a computer device having a display. The identity selector includes a graphical user interface configured to display a compound policy from a relying party, the compound policy having one or more claims and sub-claims, the graphical user interface including a plurality of regions, each region being designated to represent identity providers which satisfy claims of the compound policy and represent the identity providers in the graphical user interface by placing a representation of the identity provider in the regions where the claims of the compound policy are satisfied. A mapper is configured to associate identity providers with aspects of the compound policy to map attributes of the compound policy with attributes of the identity providers to provide the representation of the identity providers in the regions of the graphical user interface. A selection mechanism is configured to permit a selection of the at least one identity provider that satisfies the compound policy.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method for verifying an attribute for a relying party in accordance with one illustrative embodiment;

FIG. 2 is a representation of a graphical user interface showing a compound policy with claims and sub-claims;

FIG. 3 is a representation of the graphical user interface of FIG. 2 showing a sub-claim deselected;

FIG. 4 is a representation of a graphical user interface showing the compound policy and regions filled with card sets satisfying the claims in respective regions;

FIG. 5 is a representation of the graphical user interface of FIG. 4 showing another sub-claim deselected and its impact on the card sets;

FIG. 6 is a representation of the graphical user interface of FIG. 5 showing a pop-up highlighting information associated with a card; and

FIG. 7 is a block/flow diagram showing a system/method for verifying an attribute for a relying party in accordance with another illustrative embodiment.

### DETAILED DESCRIPTION OF PREFERRED EMBODIMENTS

In accordance with the present principles, a user is presented with a relying party's policy. The policy includes a set of claims and each claim can be comprised of one or multiple sub-claims. Claims and sub-claims can be displayed as a rendering of an AND-OR (conjunctive normal form (CNF)) statement on the claim and sub-claims attributes and constants. The user uses an interactive interface, such as a mouse or other tracking device, to select “OR” sub-claims which are to be considered (at least one OR term is enabled for the AND-OR statement to be solvable).

Depending on the set of selected OR sub-claims; the set of cards which can be used to satisfy the policy is displayed. This can be represented as a one-dimensional list of card combinations. An alternative is to stack the possible combinations into a deck of cards through which the user can page. However, the solution set of cards is controlled by the enabled/disabled set of OR-sub-claims. When hovering with the cursor over a card representation in the above set of cards, a pop-up element indicates which identity attributes are used to satisfy the policy claim(s). (The set of available attributes are queried from the identity provider.) Thus, the end-user is enabled to see which information items are used by the identity provider to assert the claims required by the relying party's policy.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

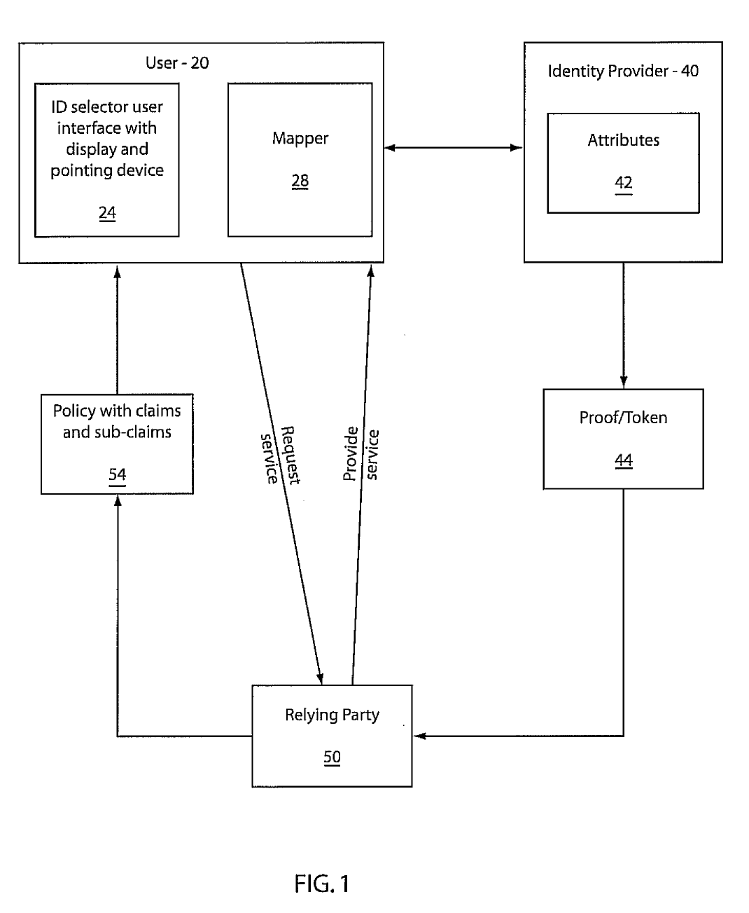

Referring now to the drawings in which like numerals represent the same or similar elements and initially to FIG. 1, a block/flow diagram shows a system/method for verifying the identity of a user in accordance with one illustrative embodiment. A user 20 requests a service, product or simply seeks access to a secure location or computer of a relying party 50 (e.g., a vendor or other entity). The relying party 50 provides a policy description 54 to the user. The policy description includes policy claims, sub-claims and conditional operations that are needed for the user 20 to win access to the relying party 50.

The relying party 50 emits an access policy 54 in the form of a conjunctive normal form “AND-OR” expression. Each term is of the form “attribute relational-operator constant” or “attribute relational-operator attribute” where an attribute is a policy language defined attribute value, such as first name, given name, age, etc. The constant value is a constant from the corresponding attribute domain, e.g. number, date, or string literals. Relational operators may include, e.g., “=”, “>”, “>=”, “!−” etc.

An AND-OR expression (conjunctive normal form) can be formulated to express complex conditions on the set of user attributes, such as (“Country of residence==Switzerland” and “age>30”) or, as another example, ((salary>100,000) or (employer==IBM)) and (gender==male). These attributes are called policy attributes, as they are the attributes used in the access policies supplied from the relying party 50.

It is now possible to extend the information card paradigm by selecting a set of cards, each of which relates to an identity provider which supplies a sub-set of the overall required attributes. A cryptographic proof system can be used to build-up combined certificates by using multiple identity providers. Multiple combinations of cards may be used to satisfy the policy claims. The identity providers provide proof that the policy claims are satisfied by the identity's actual attributes. Depending on the used cryptographic approach, this can be achieved via a zero-knowledge proof in which the actual value of the attribute is not divulged or a more traditional cryptographically secured assertion on the value of the identity attributes (in which case the attribute is visible to the relying party).

For example, a claim 1 may be satisfied by an identity provider related to cards A and B, a claim 2 can be satisfied by an identity provider of cards C, D, and A. To satisfy both claims, we can either use cards {A}, {A, C}, {A, D} or {B, A}, {B, C} and {B, D}. The exact matching depends on which attributes can be supplied by which identity providers that are related to the diverse cards. An attribute presented in a policy claim preferably does not correspond 1-to-1 to an identity provider attribute. For example, consider the required claim “age>33”. In general, identity providers supply date-of-birth. Thus, the required claims must be translated from policy attribute space into identity provider attribute space, for example by stating “current year−year(date-of-birth)>33”.

The policy claims are forwarded by the relying party 50 to an identity selector application 24 running on the user's computing equipment, which may be embodied by a fixed or mobile computer, a personal digital assistance (PDA), a cell-phone or other computing device with sufficiently powerful graphic user interface (GUI) features. Features of selector 24 include a screen of sufficient size and a pointing device (e.g., mouse, scroll-ball, touch-screen, etc.).

A mapper 28 is employed to map policy attributes of the policy 54 with identity attributes 42 of one or more identity providers 40. The mapping associates the attributes such that the policy rendered by the identity selector can be employed to determine which identity provider satisfies the claims and conditions of the policy 54. The user 20 may employ the selector 24 to graphically select alternatives (“OR” alternatives).

The mapper 28 automatically generates mappings from policy claim attributes onto identity provider attributes using, e.g., a set of computable, semantics preserving transformations. At the user level, however, the user is presented with the set of cards which eventually satisfy the policy claims of the relying party. For each card, the system indicates which attributes are supplied by the identity party associated with the card. The present embodiments provide an easy-to-use, expressive, and sufficiently powerful user-interface for the selection of cards.

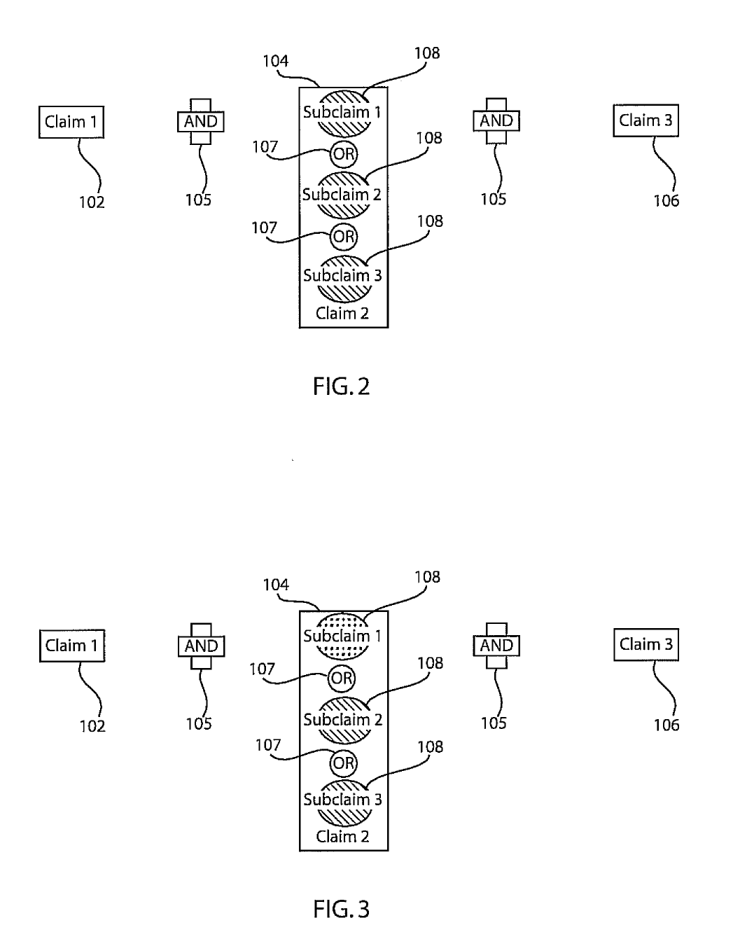

Referring to FIG. 2, policy claims 102, 104 and 106 are represented as a 2-dimensional conjunctive normal form (CNF) expression. In one embodiment, AND terms 105 are laid out horizontally, OR terms 107 are displayed vertically. Additionally, coloring, shading, or framing elements can be used to indicate the semantic difference between the AND and OR terms. The user selects, for each OR term, a non-empty set of OR-sub-claims 108 which are to be evaluated further. The set of enabled OR sub-claims 108 may be highlighted 110 or otherwise indicated to the end-user as depicted in FIG. 2.

An identity selector (not shown) establishes a relationship between the attributes present in the policy claims 102, 104, 106 and attributes provided by a potential set of identity providers. A mapping is thus created from policy attributes to identity provider attributes. Such mapping can be a one-to-one correspondence or take the form of some computable function which is equivalent to the policy claim expression. For example, if the policy claim requires “age>33” and identity providers only provide an attribute “date-of-birth”, it is possible to rewrite the policy claim expression to “(current year−year(date-of-birth))>33”. A set of known such transformations can be built into the identity selector based on a set of well known identity provider and policy claims attributes. A more flexible rewriting scheme is contemplated based on the use of ontologies establishing semantic equivalencies between attributes in the relying party claims and the identity provider space.

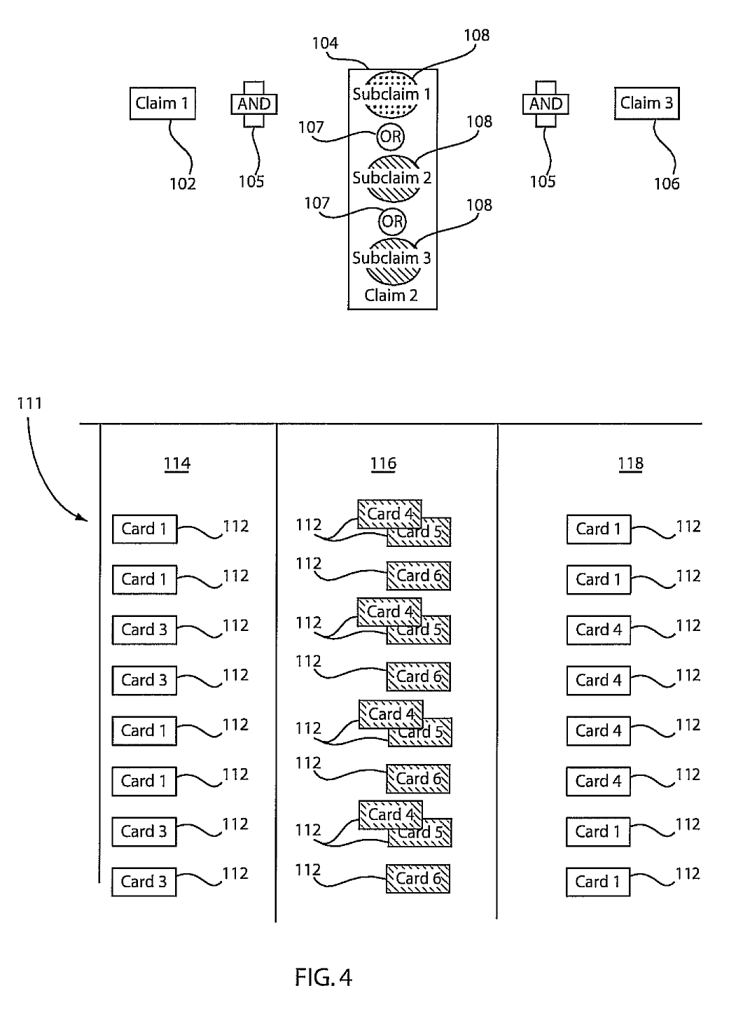

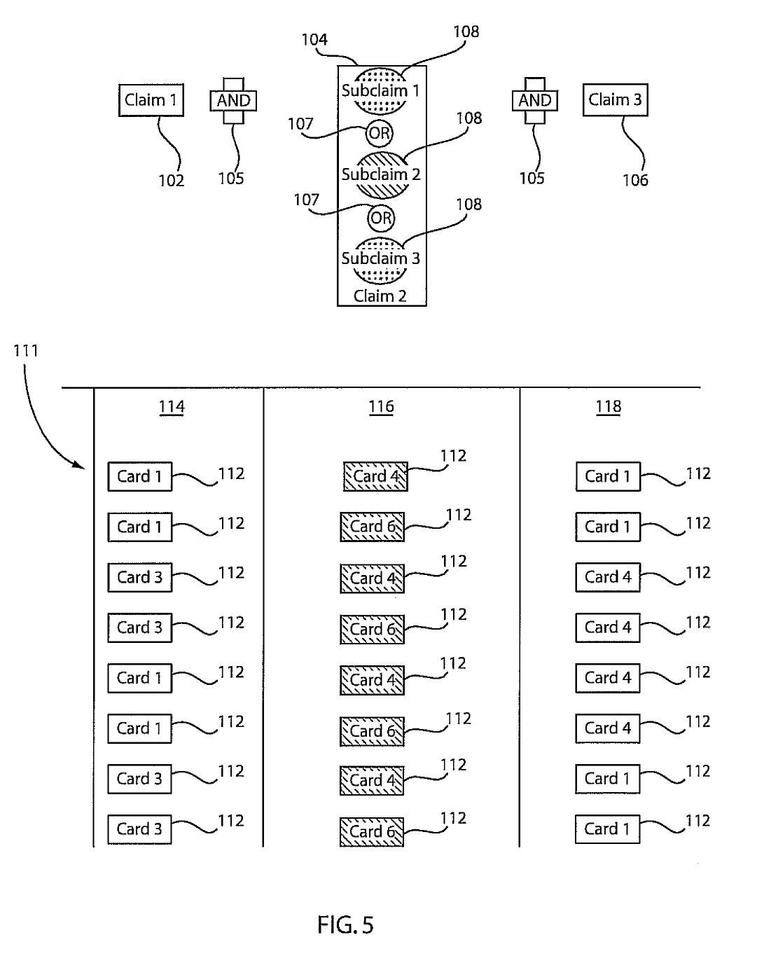

FIG. 3 shows the policy claim diagram of FIG. 2 where sub-claim 1 has been deselected by a user. Referring to FIG. 4, the identity selector displays to the end-user a set 111 of cards 112 which can be used to satisfy the policy claims. Each card 112 is related to a specific identity provider and thus to one or more of the subject's attributes provided by the identity provider. Between each AND term 105, a claim 102, 104, or 106 has a corresponding region 114, 116, or 118, respectively, having a set of cards displayed which can be used to satisfy the claim/condition.

For the selected set of OR sub-claims 108 a set of cards for each sub-claim is displayed. This can be done as a flat list of card-sets, as a stack of card-sets or as some other arrangement indicating card associated with each sub-claim. When the set of selected “OR” sub-claims 108 is modified by the user via a pointing device, the displayed set of cards is updated interactively. For example, in FIG. 4, sub-claim 1 is deselected. In FIG. 5, sub-claim 3 is also deselected which has an impact on the card sets in region 116 related to claim 2.

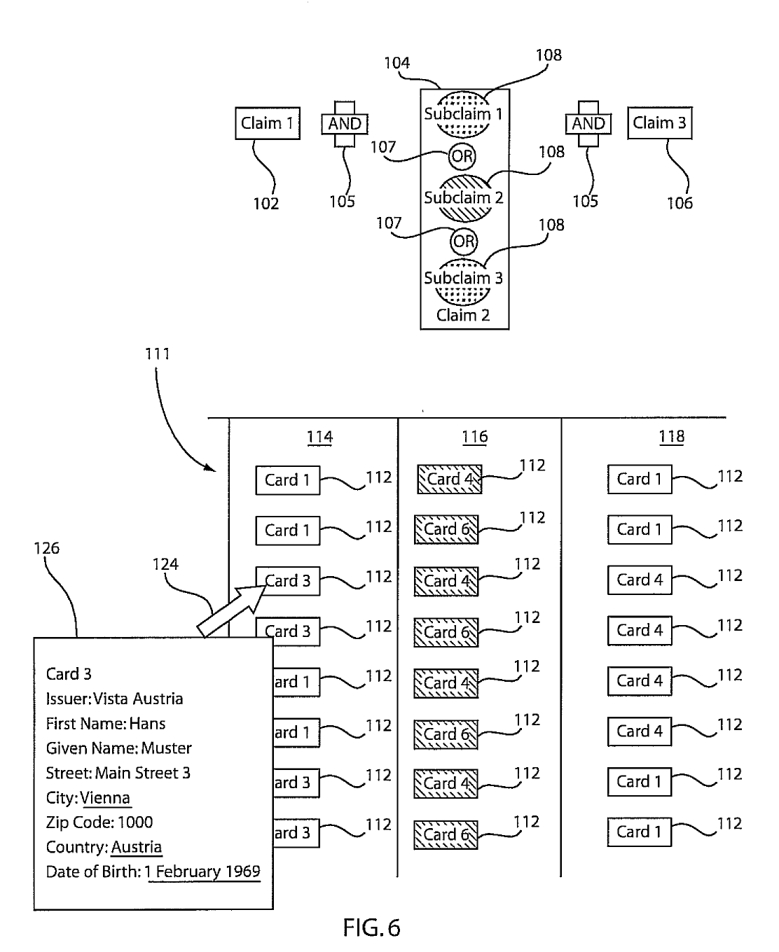

Referring to FIG. 6, a user can hover with a pointing device cursor 124 over each card to display details (for example, in a bubble or pop-up 126) on the identity provider and its supplied attributes associated with the card.

With reference to FIG. 1, once the user 20 has selected a suitable set of cards, the identity selector 24 contacts the related identity providers 40 to have the identity provider 40 prove or assert the made claims. A proof or assertion token 44 is then transferred via the identity selector 24 or directly to the relying party 50 which validates the proof respectively, verifies the assertion and grants access to the resources or services requested by the user.

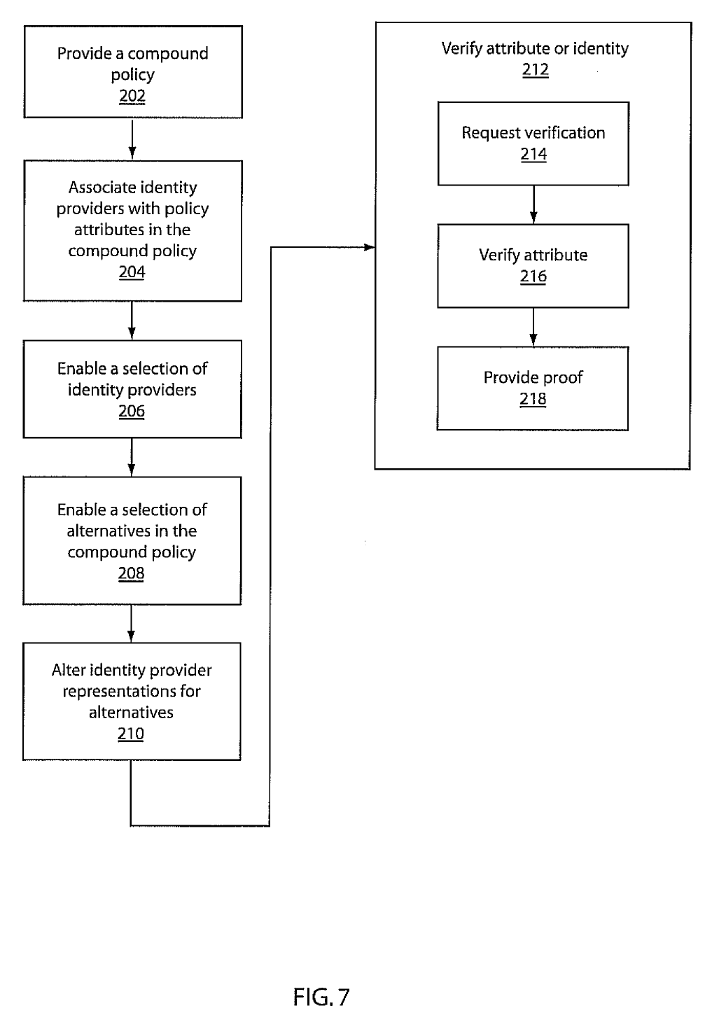

Referring to FIG. 7, a system/method for verifying identity or user attributes is illustratively shown. In block 202, a compound policy is provided by a relying party. The compound policy includes one or multiple claims and sub-claims, expressing conditions over attributes and constants. In preferred embodiments, the compound policy is complex and includes a plurality of claims and sub-claims. The compound policy is preferably generated by a graphical user interface (GUI) to display the compound policy to a user. The conditions/claims/sub-claims of the compound policy are preferably expressed in conjunctive normal form.

In block 204, identity providers or verifiers are associated with aspects of the compound policy by mapping attributes of the compound policy with attributes of the identity providers. In one embodiment, the graphical user interface includes a plurality of regions, and each region is designated to represent identity providers which satisfy claims and/or sub-claims of the compound policy. The identity providers are represented in the graphical user interface by, e.g., cards. The representations (e.g., cards) of the identity providers are placed in the regions where the claims/subclaims of the compound policy are satisfied.

In block 206, a selection of at least one identity provider that satisfies the compound policy is enabled. This may include providing a pointing mechanism for a user to point to in the graphical user interface to select identity providers that should be employed to verify an identity of attribute of the user to a relying party. In block 208, the compound policy may include alternative conditions (“OR”s). These alternative conditions may provide opportunities for user selections of the alternative conditions. This selection from among the alternative conditions causes the representations of the identity providers to be altered in accordance with new conditions of the compound policy in block 210. This may include the appearance or disappearance of cards or stacks of cards representing the identity providers in the GUI.

In block 212, verification of at least an attribute of the user by the at least one identity provider in accordance with the selection is performed. This process may include requesting verification of the at least one attribute of the user from the at least one identity provider in block 214, verifying the at least one attribute of the user in block 216, and providing proof of the verification to the relying party in block 218. The proof preferably includes a zero-knowledge proof in which an actual value of an attribute is not divulged.

Having described preferred embodiments of a system and method for interactive selection of identity information satisfying policy constraints (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for verifying an attribute, comprising:
providing a compound policy by a relying party, the compound policy having one or more claims and/or sub-claims expressing conditions on attributes and constants;
associating identity providers with aspects of the compound policy by mapping attributes of the compound policy with attributes of the identity providers;
enabling a selection of at least one identity provider that satisfies the compound policy; and
verifying at least one attribute of the user by at least one identity provider in accordance with the selection.

2. The method as recited in claim 1, wherein providing includes generating a graphical user interface to display the compound policy.

3. The method as recited in claim 2, wherein the graphical user interface includes a plurality of regions, each region being designated to represent identity providers which satisfy claims of the compound policy.

4. The method as recited in claim 3, further comprising representing identity providers in the graphical user interface and placing a representation of the identity provider in the regions where the claims of the compound policy are satisfied.

5. The method as recited in claim 1, wherein the compound policy includes alternative sub-claims and further comprising selecting from among the alternative sub-claims.

6. The method as recited in claim 5, wherein selecting from among the alternative sub-claims causes the representations of the identity providers to be altered in accordance with newly selected sub-claims of the compound policy.

7. The method as recited in claim 1, wherein the compound policy includes alternative claims and further comprising selecting from among the alternative claims.

8. The method as recited in claim 1, wherein relationships between at least one of claims and sub-claims are expressed in conjunctive normal form.

9. The method as recited in claim 1, wherein verifying includes:
requesting verification of the at least one attribute of the user from at least one identity provider;
verifying at least one attribute of the user; and
providing proof of the verification to the relying party.

10. The method as recited in claim 1, wherein the proof includes a zero-knowledge proof in which an actual value of an attribute is not divulged.

11. A computer readable medium comprising a computer readable program for verifying an attribute, wherein the computer readable program when executed on a computer causes the computer to perform the steps of;
providing a compound policy by a relying party, the compound policy having one or more claims and/or sub-claims expressing conditions on attributes and constants;
associating identity providers with aspects of the compound policy by mapping attributes of the compound policy with attributes of the identity providers;
enabling a selection of at least one identity provider that satisfies the compound policy; and
verifying at least one attribute of the user by at least one identity provider in accordance with the selection.

12. The computer readable medium as recited in claim 11, wherein providing includes generating a graphical user interface to display the compound policy.

13. The computer readable medium as recited in claim 12, wherein the graphical user interface includes a plurality of regions, each region being designated to represent identity providers which satisfy claims of the compound policy.

14. The computer readable medium as recited in claim 13, further comprising representing identity providers in the graphical user interface and placing a representation of the identity provider in the regions where the claims of the compound policy are satisfied.

15. The computer readable medium as recited in claim 11, wherein the compound policy includes alternative sub-claims and further comprising selecting from among the alternative sub-claims.

16. The computer readable medium as recited in claim 15, wherein selecting from among the alternative sub-claims causes the representations of the identity providers to be altered in accordance with new conditions of the compound policy.

17. A system for verifying an attribute, comprising:
an identity selector configured on a computer device having a display, the identity selector including:
a graphical user interface configured to display a compound policy from a relying party, the compound policy having one or more claims and sub-claims, the graphical user interface including a plurality of regions, each region being designated to represent identity providers which satisfy claims of the compound policy and represent the identity providers in the graphical user interface by placing a representation of the identity provider in the regions where the claims of the compound policy are satisfied;
a mapper configured to associate identity providers with aspects of the compound policy to map attributes of the compound policy with attributes of the identity providers to provide the representation of the identity providers in the regions of the graphical user interface; and
a selection mechanism configured to permit a selection of the at least one identity provider that satisfies the compound policy.

18. The system as recited in claim 17, wherein the compound policy includes alternative sub-claims and a user selects from among the alternative sub-claims using the selection mechanism such that the representations of the identity providers are altered in accordance with new conditions of the compound policy.

19. The system as recited in claim 18, wherein relationships between at least one of claims and sub-claims are expressed in conjunctive normal form.

20. The system as recited in claim 17, wherein the identity selector includes one of a computer device, and a cellular telephone.
